(19) United States
(12) Patent Application Publication
(10) Pub. No.: US 2026/0104655 A1
(43) Pub. Date: Apr. 16, 2026

(54) IMAGE FORMING APPARATUS

(71) Applicant: KYOCERA DOCUMENT SOLUTIONS INC., OSAKA (JP)

(72) Inventors: KATSUNORI TERAOKA, OSAKA-SHI, OSAKA (JP); TOMOFUMI SHIMIZU, OSAKA-SHI, OSAKA (JP); KEIJI OZAWA, OSAKA-SHI, OSAKA (JP); TERUYUKI UEMURA, OSAKA-SHI, OSAKA (JP)

(21) Appl. No.: 19/353,574

(22) Filed: Oct. 8, 2025

(30) Foreign Application Priority Data
Oct. 11, 2024 (JP) 2024-178687

(51) Int. Cl. G03G 15/02; C08K 3/04

(52) U.S. Cl. CPC G03G 15/0233; C08K 3/04; G03G 15/0283; C08K 2201/001

(57) ABSTRACT

Provided is an image forming apparatus capable of suppressing an influence of environment when printing on a print quality. The image forming apparatus includes a photosensitive member, a charging roller, and a power supply. The photosensitive member has a relative dielectric constant of 3.7 or more and 6.2 or less. The charging roller charges the photosensitive member and has a surface rotational resistance of 5.2 log Ω or more and 6.1 log Ω or less. The power supply applies a DC voltage to the charging roller.

### CROSS-REFERENCE TO RELATED PATENT APPLICATION

This application claims the benefit of Japanese Priority Patent Application JP 2024-178687 filed Oct. 11, 2024, the entire contents of which are incorporated herein by reference.

### FIELD OF THE DISCLOSURE

The present disclosure relates to an image forming apparatus used for electrophotographic printing.

### BACKGROUND OF THE DISCLOSURE

In an image forming apparatus using an electrophotographic process, a drum-shaped photosensitive member is used as an image carrier, and after a surface of the photosensitive member is uniformly charged by a charging apparatus, light is irradiated onto the surface of the photosensitive member by an exposure apparatus to form a static latent image in which a charge in a light-exposed areas is reduced. The electrostatic latent image is then developed into a toner image using a developing apparatus, and the toner image is directly transferred to printing paper by applying a transfer voltage of an opposite polarity to the toner and a transfer apparatus, or the toner image is primary transferred to an intermediate transfer medium and then secondary transferred to printing paper, after which the toner image is thermally fixed to the paper using a fixing apparatus.

To improve a performance of the image forming apparatus, research and development is continuously conducted on the photosensitive member. For example, Japanese Patent Application Publication No. 2022-181418 discloses an electrophotographic photosensitive member that can form a photosensitive layer with good quality, has excellent charge stability, and suppresses a transfer memory.

### SUMMARY OF THE DISCLOSURE

To achieve the above object, an image forming apparatus according to an embodiment of the present disclosure includes a photosensitive member, a charging roller, and a power supply. The photosensitive member has a relative dielectric constant of 3.7 or more and 6.2 or less. The charging roller charges the photosensitive member and has a surface rotational resistance of 5.2 log Ω or more and 6.1 log Ω or less. The power supply applies a DC voltage to the charging roller.

### BRIEF DESCRIPTION OF THE DRAWINGS

FIG. 1 is a schematic diagram of an image forming apparatus according to an embodiment of the present disclosure.

FIG. 2 is a schematic diagram of an image forming unit provided in the image forming apparatus.

FIG. 3 is a schematic diagram of a photosensitive member provided in the image forming apparatus.

FIG. 4 is a schematic diagram of a charging roller provided in the image forming apparatus.

### DETAILED DESCRIPTION OF THE EXEMPLARY EMBODIMENTS

Embodiments of the present disclosure will be described.

### [Configuration of Image Forming Apparatus]

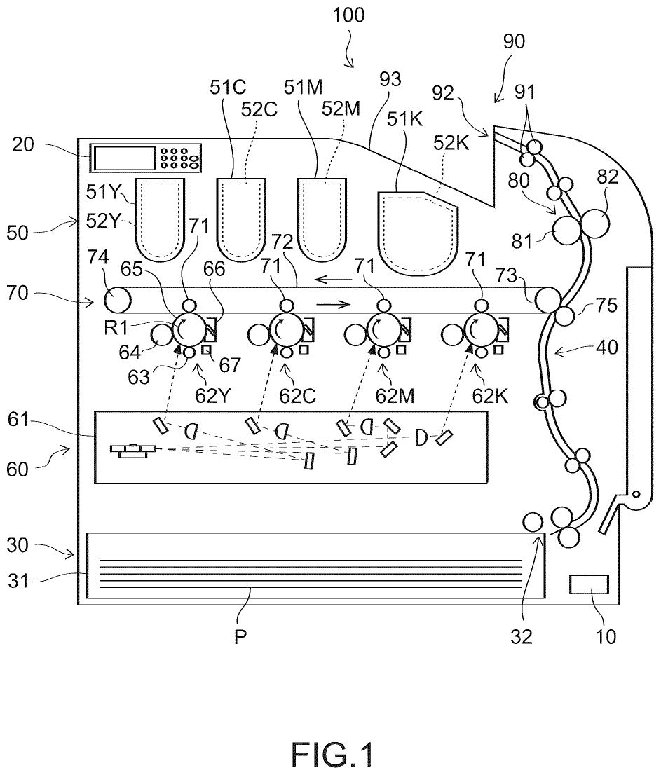

An image forming apparatus 100 according to an embodiment of the present disclosure will be described. FIG. 1 is a schematic diagram showing a configuration of the image forming apparatus 100. The image forming apparatus 100 is, for example, a tandem-type color printer.

As shown in FIG. 1, the image forming apparatus 100 includes a control section 10, an operation section 20, a paper feeding section 30, a transport section 40, a toner supply section 50, an image forming section 60, a transfer apparatus 70, a fixing apparatus 80, and an ejection section 90.

The control section 10 controls an operation of each part of the image forming apparatus 100. The control section 10 includes an arithmetic processing unit and a memory unit, which are not shown in FIG. 1. The arithmetic processing unit is, for example, a CPU (central processing unit), and the memory unit is, for example, a semiconductor memory or an HDD (hard disk drive). The arithmetic processing unit controls the operation of the image forming apparatus 100 by executing a control program. The memory unit stores the control program.

The operation section 20 receives an instruction from a user. When the operation section 20 receives the instruction from the user, it sends a signal indicating the instruction from the user to the control section 10. This initiates an image forming operation of the image forming apparatus 100.

The paper feed section 30 has a paper feed cassette 31 and a paper feed roller assembly 32. The paper feed cassette 31 can accommodate several sheets of recording medium P. The recording medium is, for example, printing paper. The paper feed roller assembly 32 feeds the recording medium P accommodated in the paper feed cassette 31 one sheet at a time to a transport section 40.

The transport section 40 is equipped with rollers and guide members. The transport section 40 extends from the paper feed section 30 to the ejection section 90. The transport section 40 transports the recording medium P from the paper feed section 30 to the ejection section 90 via the image forming section 60 and the fixing apparatus 80.

The toner supply section 50 supplies toner to the image forming section 60. The toner supply section 50 includes a first mounting portion 51Y, a second mounting portion 51C, a third mounting portion 51M, and a fourth mounting portion 51K. The first mounting portion 51Y is equipped with a first toner container 52Y. The second mounting portion 51C is equipped with a second toner container 52C, the third mounting portion 51M is equipped with a third toner container 52M, and the fourth mounting portion 51K is equipped with a fourth toner container 52K.

The first toner container 52Y contains yellow toner, the second toner container 52C contains cyan toner, the third toner container 52M contains magenta toner, and the fourth toner container 52K contains black toner. Note that the colors of the toners are not limited to those shown here and may be other colors. The number of colors may also be one or more.

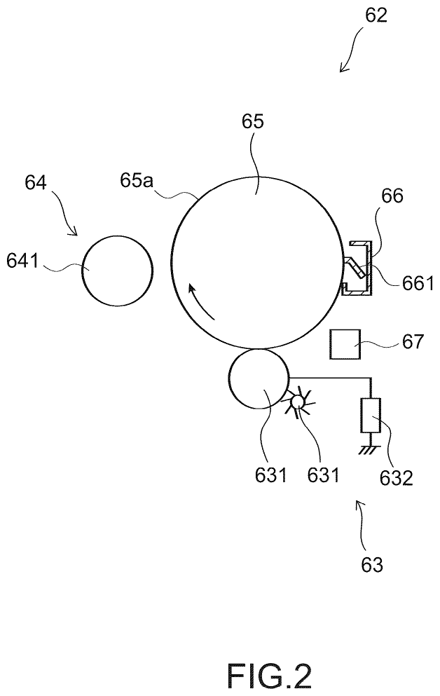

The image forming section 60 includes an exposure apparatus 61, a first image forming unit 62Y, a second image forming unit 62C, a third image forming unit 62M, and a fourth image forming unit 62K. FIG. 2 is a schematic diagram of the image forming unit 62. The first image forming unit 62Y, the second image forming unit 62C, the third image forming unit 62M, and the fourth image forming unit 62K have the same configuration as the image forming unit 62 shown in FIG. 2. The image forming unit 62 includes a charging apparatus 63, a developing apparatus 64, a photosensitive member 65, a cleaning apparatus 66, and a static elimination apparatus 67. The charging apparatus 63, the developing apparatus 64, the cleaning apparatus 66, and the static elimination apparatus 67 are arranged along a surface 65a of the photosensitive member 65.

The exposure apparatus 61 (see FIG. 1) irradiates light (dashed lines in the figure) onto the surface 65a of the photosensitive member 65 of each image forming unit 62 to expose the surface 65a. The exposure apparatus 61 irradiates light for each color to each image forming unit 62 based on the supplied image data and performs exposure. The exposure apparatus 61 can perform the exposure using laser light.

The photosensitive member 65 forms an electrostatic latent image when exposed by the exposure apparatus 61. The surface 65a of the photosensitive member 65 is charged with a positive or negative charge in advance. When this surface 65a is exposed by the exposure apparatus 61, the charging is attenuated in an area where the light is irradiated, forming the electrostatic latent image. As the photosensitive member 65, an OPC (Organic Photo Conductor) may be used, for example. A detailed configuration of the photosensitive member 65 will be described later. The photosensitive member 65 rotates in the direction indicated by the arrow in FIG. 2 (clockwise direction).

The charging apparatus 63 charges the surface 65a positively or negatively. The charging apparatus 63 includes a charging roller 631, a charging voltage power supply 632, and a cleaning brush 633. The charging roller 631 contacts the surface 65a and uniformly charges the surface 65a. A detailed configuration of the charging roller 631 will be described later. The charging voltage power supply 632 applies a charging voltage to the charging roller. This charging voltage is preferably a direct current voltage. The cleaning brush 633 contacts the charging roller 631 and cleans the charging roller 631.

The developing apparatus 64 supplies toner supplied from the toner supply section 50 to the surface 65a. The developing apparatus 64 includes a developing roller 641, as shown in FIG. 2. The toner supplied from the toner container is mixed with a magnetic carrier to form a two-component developing agent. At this time, the toner becomes charged to the same polarity as the surface 65a due to friction with the carrier.

The two-component developing agent is adsorbed onto the developing roller 641 by magnetic force and transported to a position opposite the photosensitive member 65. A voltage is applied between the developing roller 641 and the photosensitive member 65, causing the toner in the two-component developing agent to adhere to the electrostatic latent image on surface 65a. As a result, a toner image corresponding to the electrostatic latent image is formed on surface 65a.

The developing apparatus 64 of the first image forming unit 62Y is connected to the first toner container 52Y, and yellow toner is supplied. Therefore, a yellow toner image is formed on the surface of the photosensitive member 65 of the first image forming unit 62Y. Similarly, the developing apparatus 64 of the second image forming unit 62C is connected to the second toner container 52C, and a cyan toner image is formed on the surface of the photosensitive member 65 of the second image forming unit 62C.

Furthermore, the developing apparatus 64 of the third image forming unit 62M is connected to the third toner container 52M, and a magenta toner image is formed on the surface of the photosensitive member 65 of the third image forming unit 62M. The developing apparatus 64 of the fourth image forming unit 62K is connected to the fourth toner container 52K, and a black toner image is formed on the surface of the photosensitive member 65 of the fourth image forming unit 62K.

The cleaning apparatus 66 recovers the toner adhering to the surface 65a after transfer by a primary transfer roller 71 described below. Specifically, the cleaning apparatus 66 presses a cleaning blade 661 against the surface 65a to recover toner adhering to the surface 65a. The static elimination apparatus 67 irradiates the surface 65a with static elimination light to eliminate static charge on the surface 65a.

The transfer apparatus 70 (see FIG. 1) transfers the toner image from the photosensitive member 65 to the recording medium P, which is the transfer medium. Specifically, the transfer apparatus 70 transfers toner images of respective colors formed on the surface 65a of the photosensitive member 65 of each image forming unit 62 to the recording medium P in a superimposed fashion. The transfer apparatus 70 can transfer each toner image onto the recording medium P in a secondary transfer method (intermediate transfer method). As a configuration for the secondary transfer method, the transfer apparatus 70 includes four primary transfer rollers 71, an intermediate transfer belt 72, a drive roller 73, a follower roller 74, and a secondary transfer roller 75.

The intermediate transfer belt 72 is an endless belt stretched over the four primary transfer rollers 71, the drive roller 73, and the follower rollers 74. The intermediate transfer belt 72 is driven in response to rotation of the drive roller 73. In FIG. 1, the intermediate transfer belt 72 rotates in the direction indicated by the arrow in FIG. 1 (counterclockwise). The follower roller 74 is rotated in response to driving of the intermediate transfer belt 72.

Each image forming unit 62 is arranged opposite a lower surface of the intermediate transfer belt 72 in the order of the first image forming unit 62Y to the fourth image forming unit 62K from an upstream side to a downstream side of a driving direction of the lower surface of the intermediate transfer belt 72.

Each primary transfer roller 71 is arrange opposite each photosensitive member 65 via the intermediate transfer belt 72 and presses against each photosensitive member 65. Therefore, the toner image formed on the surface 65a of each photosensitive member 65 is sequentially transferred to the intermediate transfer belt 72 by each primary transfer roller 71. In the configuration of FIG. 1, the yellow toner image, the cyan toner image, the magenta toner image, and the black toner image are transferred to the intermediate transfer belt 72 in this order, but the order of the toner images is not limited to this. Hereinafter, a toner image layered by the layered yellow toner image, the cyan toner image, the magenta toner image, and the black toner image is referred to as a “layered toner image.”

The secondary transfer roller 75 is arranged opposite the drive roller 73 via the intermediate transfer belt 72. The secondary transfer roller 75 is pressed against the drive roller 73. As a result, a transfer nip (contact area) is formed between the secondary transfer roller 75 and the drive roller 73, and when the recording medium P passes through the transfer nip, the layered toner image on the intermediate transfer belt 72 is transferred to the recording medium P by the secondary transfer roller 75. A layering order of the layered toner image on the recording medium P is opposite to that of the layered toner image on the intermediate transfer belt 72. The recording medium P with the transferred layered toner image is transported toward the fixing apparatus 80 by the transport section 40.

The fixing apparatus 80 fixes the layered toner image to the recording medium P. The fixing apparatus 80 includes a heating member 81 and a pressing member 82. The heating member 81 and the pressing member 82 are arranged opposite each other to form a fixing nip. The recording medium P transported from the image forming section 60 passes through the fixing nip, where it is heated to a predetermined fixing temperature while being pressurized, causing the layered toner image to be fixed to the recording medium P. The recording medium P is transported from the fixing apparatus 80 to the ejection section 90 by the transport section 40.

The ejection section 90 ejects the recording medium P with the layered toner image fixed. The ejection section 90 includes an ejection roller pair 91, an ejection port 92, and an ejection tray 93. The ejection roller pair 91 transports the recording medium P to the ejection tray 93 through the ejection port 92.

An image forming method using the image forming apparatus 100 will be described. When the control section 10 acquires the image data and the operation section 20 receives the instruction from the user to initiate the image forming operation, the photosensitive member 65 is rotated in each image forming unit 62, and the charging roller 631 uniformly charges the surface 65a.

Next, the exposure apparatus 61 exposes the surface 65a of each image forming unit 62 in accordance with the image data, thereby forming the electrostatic latent image of each color on the surface 65a. The developing apparatus 64 of each image forming unit supplies the toner of each color to the surface 65a, causing the toner to adhere electrostatically to the electrostatic latent images of each color. As a result, toner images of respective colors are formed on the surface 65a of each photosensitive member 65. If an amount of the toner filled in each developing apparatus 64 falls below a specified value, toner is replenished from the first toner container 52Y to the fourth toner container 52K to each developing apparatus 64.

Between the primary transfer roller 71 and the photosensitive member 65, an electric field is applied at a predetermined transfer voltage by the primary transfer roller 71. As a result, the toner images of respective colors on the surface 65a are primary transferred to the intermediate transfer belt 72. The toner images of respective colors are layered, forming the layered toner image on the intermediate transfer belt 72. Subsequently, to prepare for formation of a new electrostatic latent image, any remaining toner on the surface 65a after the primary transfer is removed by the cleaning apparatus 66.

As the intermediate transfer belt 72 rotates counterclockwise in conjunction with the rotation of the drive roller 73, the recording medium P is transported by the transport section 40 to the transfer nip between the secondary transfer roller 75 and the drive roller 73 at a predetermined timing, and the layered toner image on the intermediate transfer belt 72 is secondary transferred to the recording medium P. The recording medium P on which the layered toner image is secondary transferred is transported to the fixing apparatus 80 by the transport section 40.

The recording medium P transported to the fixing apparatus 80 is heated and pressurized by the heating member 81 and the pressurizing member 82, causing the layered toner image to be fixed to the surface of the recording medium P, thereby forming a color image on the recording medium P. The recording medium P with the color image formed thereon is ejected to the ejection tray 93 at the ejection section 90.

The image forming apparatus 100 has the above configuration. The configuration of the image forming apparatus according to the present disclosure is not limited to the above, and may include the photosensitive member 65 and the charging roller 631 having the configuration described below. For example, the image forming apparatus 100 is configured to form the color image, but the image forming apparatus according to the present disclosure may also be an image forming apparatus capable of forming a monochrome image. In this case, the image forming apparatus may include only one image forming unit.

Additionally, the image forming apparatus 100 is configured as a tandem-type image forming apparatus, but the image forming apparatus according to the present disclosure may be a rotary-type image forming apparatus. Furthermore, the image forming apparatus 100 is configured as a touchdown development-type image forming apparatus, but the image forming apparatus according to the present disclosure may also be an image forming apparatus using a development method other than the touchdown development method.

Furthermore, although the image forming apparatus 100 is an intermediate transfer type image forming apparatus, the image forming apparatus according to the present disclosure may also be a direct transfer type image forming apparatus. In this case, the toner image is directly transferred from the photosensitive member 65 to the recording medium P while the photosensitive member 65 is in contact with the recording medium P. Furthermore, although each image forming unit 62 is provided with the static elimination apparatus 67, each image forming unit 62 may not be provided with the static elimination apparatus 67.

### [Configuration of Photosensitive Member]

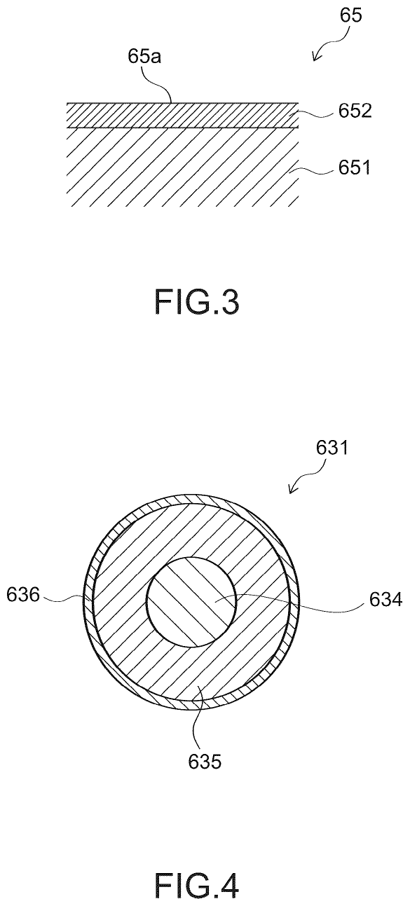

The configuration of the photosensitive member 65 described above will be described. FIG. 3 is a cross-sectional diagram of the surface of the photosensitive member 65. As shown in FIG. 3, the photosensitive member 65 includes a conductive base 651 and a photosensitive layer 652. The conductive base 651 is made of a conductive material such as aluminum and has a cylindrical shape. The photosensitive layer 652 is made of an organic photosensitive material and is formed as a thin film on the conductive base 651. Generally, the photosensitive member is classified into “single-layer photosensitive member” including a single photosensitive layer, and a “multi-layer photosensitive member” including a plurality of the photosensitive layers. Preferably, the photosensitive member 65 is the single-layer photosensitive member. Additionally, an undercoat layer may be provided between the conductive base 651 and the photosensitive layer 652.

The photosensitive layer 652 is made of the organic photosensitive material as described above, and specifically contains a charge-generating material, a hole-transport material, an electron-transport material, and a binder resin.

Examples of the charge-generating material include a phthalocyanine pigment, a perylene-based pigment, a bisazo pigment, a trisazo pigment, a dithioketopyrrolopyrrole pigment, a metal-free azo compound, a metal azo compound, a squaraline pigment, an indigo pigment, an azulenium pigment, a cyanine pigment, powder of an inorganic photoconductive material (e.g., selenium, selenium-tellurium, selenium-arsenic, cadmium sulfide, and amorphous silicon), a pyrilium pigment, an anthraquinone-based pigment, a triphenylmethane-based pigment, a threne-based pigment, a toluidine-based pigment, a pyrazoline-based pigment, a quinacridone-based pigments, and the like. The photosensitive layer 652 may contain only one type of the charge-generating material or may contain two or more types of charge-generating materials.

Specifically, as the charge-generating material, Y-type titanyl phthalocyanine, which is the phthalocyanine pigment, can be used. The Y-type titanyl phthalocyanine is shown in the following (Formula 1).

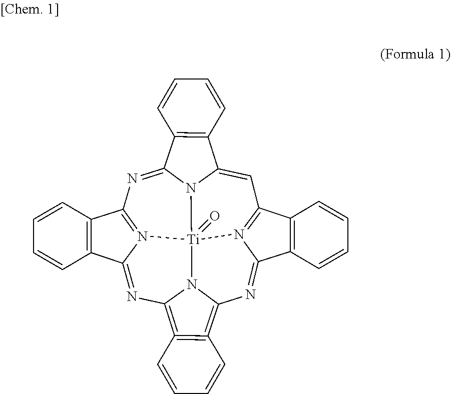

Examples of the hole-transport material include a triphenylamine derivative, a diamine derivative (e.g., N,N,N′,N′-tetraphenylbenzene derivative, N,N,N′,N′-tetraphenylphenylenediamine derivative, N,N,N′,N′,N′-tetraphenylnaphthylenediamine derivative, N,N,N′,N′,N′-tetraphenylnaphthylenediamine derivative, and di(aminophenyl ethylene)benzene derivative), an oxadiazole compound (e.g., 2,5-di(4-methylaminophenyl)-1,3,4-oxadiazole), a styryl-based compound (e.g., 9-(4-diethylaminostyryl)anthracene), a carbazole-based compound (e.g., polyvinylcarbazole), an organic polysilane compound, a pyrazoline-based compound (e.g., 1-phenyl-3-(p-dimethylaminophenyl)pyrazoline), a hydrazone-based compound, an indole-based compound, an oxazole-based compound, an isoxazole-based compound, a thiazole-based compound, a thiaazole-based compound, an imidazole-based compound, a pyrazole-based compound, a triazole compound, and the like. The photosensitive layer 652 may contain only one type of the hole-transport material or may contain two or more types of hole-transport materials.

Specifically, the following substance shown in (Formula 2) can be used as hole-transport materials.

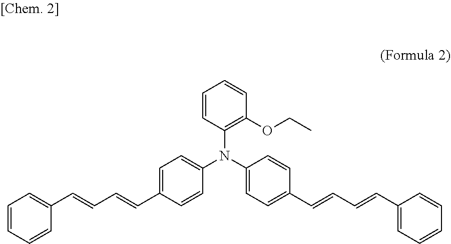 [SMILES: CCOc1ccccc1N(c1ccc(/C=C/C=C/c2ccccc2)cc1)c1ccc(/C=C/C=C/c2ccccc2)cc1]

Examples of the electron-transport material include a quinone-based compound, a diimide-based compound, a hydrazone-based compound, a malononitrile-based compound, a thiopyran-based compound, a trinitrothioxantone compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacridine, succinic anhydrid, maleic anhydride, dibromomaleic anhydride, and the like. Examples of the quinone compound include a diphenoxyquinone-based compound, an azoquinone-based compound, an anthraquinone-based compound, a naphthoquinone-based compound, a nitroanthraquinone-based compound, a dinitroanthraquinone-based compound, and the like. The photosensitive layer 652 may contain only one type of the electron-transport material or may contain two or more types of the electron-transport materials.

Specifically, the following substance shown in (Formula 3) can be used as the electron-transport material.

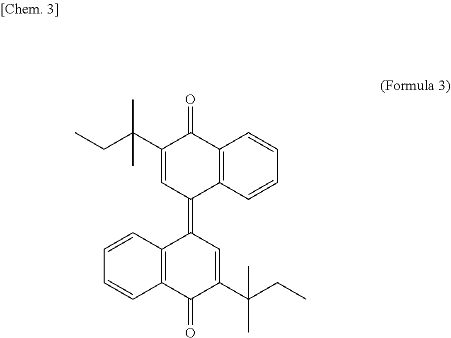 [SMILES: CCC(C)(C)C1=C/C(=C2/C=C(C(C)(C)CC)C(=O)c3ccccc32)c2ccccc2C1=O]

Examples of the binder resin include a polyarylate resin, a polycarbonate resin, a styrene-based resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diacrylate resin, a ketone resin, a polyvinyl butyral resin, a polyvinyl acetate resin, a polyether resin, a silicone resin, an epoxy resin, a phenolic resin, a urea resin, a melamine resin, an epoxy-acrylic acid-based resin, a urethane-acrylic acid-based copolymer, and the like. The photosensitive layer 652 may contain only one type of the binder resin or may contain two or more types of the binder resins.

Specifically, as the binder resin, the polyarylate resin having repeating units shown in the following (Formula 4) to (Formula 7) can be used. Respective repeating units are: for example, 40 mass parts of (Formula 4), 10 mass parts of (Formula 5), 25 mass parts of (Formula 6), and 25 mass parts of (Formula 7).

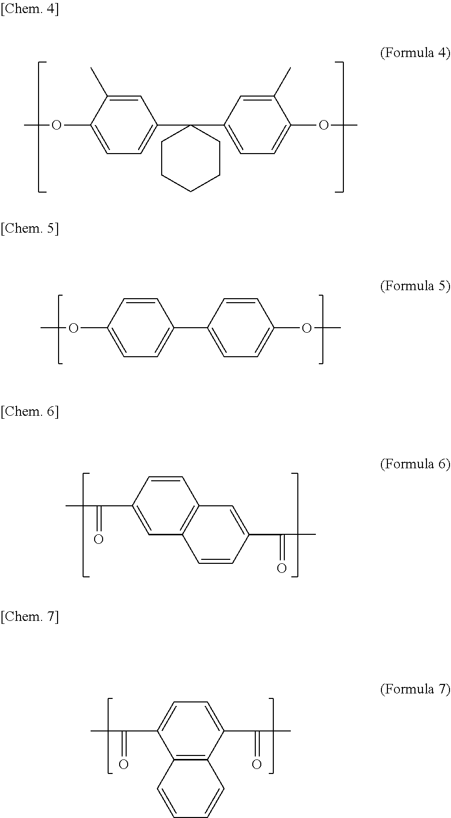

The photosensitive layer 652 has the above configuration. Note that the photosensitive layer 652 may also contain additives in addition to the materials described above. Examples of the additives include, for example, a ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, a leveling agent, and the like. The photosensitive layer 652 may contain one or more of these additives.

The relative dielectric constant of the photosensitive member 65 is preferably 3.7 or more and 6.2 or less. The relative dielectric constant of the photosensitive member 65 can be adjusted by a content of the charge-generating material in the photosensitive layer 652. Specifically, when using the Y-type titanyl phthalocyanine as the charge-generating material as shown in the above (Formula 1), the relative dielectric constant of the photosensitive member 65 can be set to 3.7 or more and 6.2 or less by adjusting a content of the Y-type titanyl phthalocyanine to 2 phr or more and 7 phr or less. Note that “phr” denotes mass parts of the Y-type titanyl phthalocyanine per 100 mass parts of the binder resin.

### [Method for Manufacturing Photosensitive Member]

A method for manufacturing the photosensitive member 65 will be described. The photosensitive member 65 can be manufactured by forming the photosensitive layer 652 on the conductive base 651. The photosensitive layer 652 can be formed on the conductive base 651 by preparing a coating liquid by mixing a solvent, the charge-generating material, the hole-transport material, the electron-transport material, and the binder resin described above, applying the coating liquid to the conductive base 651, and removing the solvent. The mixing of the materials can be conducted using a bead mill, a roll mill, a ball mill, an attritor, a paint shaker, a rod-shaped ultrasonic vibrator, or an ultrasonic disperser.

The solvent may be any substance capable of dissolving the binder resin, such as alcohols (specifically, methanol, ethanol, isopropanol, and butanol, etc.), aliphatic hydrocarbons (specifically, n-hexane, octane, and cyclohexane, etc.), aromatic hydrocarbons (specifically, benzene, toluene, and xylene, etc.), halogenated hydrocarbons (specifically, dichloromethane, dichloroethane, carbon tetrachloride, and chlorobenzene, etc.), ethers (specifically, dimethyl ether, diethyl ether, tetrahydrofuran, ethylene glycol dimethyl ether, and diethylene glycol dimethyl ether, etc.), ketones (specifically, acetone, methyl ethyl ketone, and cyclohexanone, etc.), esters (specifically, ethyl acetate and methyl acetate, etc.), dimethylformaldehyde, dimethylformamide, dimethyl sulfoxide, and the like.

Applying the coating liquid can be conducted using a method capable of uniformly applying the coating liquid, i.e., using any of a dip coating method, a spray coating method, a spin coating method, a bar coating method, and a blade coating. The solvent can be removed by heating, vacuuming, or a combination of heating and vacuuming, and specifically using a high-temperature dryer or a vacuum dryer.

### [Configuration of Charging Roller]

A configuration of the charging roller 631 described above will be described. FIG. 4 is a cross-sectional diagram of the charging roller 631. As shown in FIG. 4, the charging roller 631 includes a conductive shaft 634, an elastic layer 635, and a surface layer 636.

The conductive shaft 634 is a rod-shaped member made of a conductive material. Examples of the conductive material include metals such as iron, aluminum, titanium, copper, and nickel; alloys such as stainless steel, duralumin, brass, and bronze; and composite materials made by bonding carbon black or carbon fibers with plastic. The conductive shaft 634 may have a cylindrical shape or a tubular shape.

The elastic layer 635 has both conductivity and elasticity and is arranged around the conductive shaft 634. A material for the elastic layer 635 may be a mixture of an elastic material and a conductive material. Examples of the elastic materials include hydrin rubber, polyurethane elastomers, styrene-butadiene rubber (SBR), polynorbornene rubber, ethylene-propylene-diene rubber (EPDM), acrylonitrile-butadiene rubber (NBR), hydrogenated acrylonitrile-butadiene rubber (H-NBR), butadiene rubber (BR), isoprene rubber (IR), natural rubber (NR), and silicone rubber. Hydrin rubber is more suitable as the elastic material, and specifically, epichlorohydrin rubber is preferrable.

The conductive material mixed with the above elastic materials is at least one of an electronic conductive material and an ionic conductive material. Examples of electronic conductive materials include carbon black, graphite, potassium titanate, iron oxide, titanium oxide, zinc oxide, and tin oxide. Tin oxide and carbon black are more suitable as electronic conductive materials. A content ratio of the electronic conductive material in the elastic layer 635 is preferably 5 mass parts or more and 40 mass parts or less per 100 mass parts of the elastic material.

Examples of the ionic conductive materials include organic salts (e.g., sodium trifluoroacetate), inorganic salts (e.g., quaternary ammonium salts), metal complexes, and ionic liquid. Sodium trifluoroacetate is more suitable as an ionic conductive material. A content ratio of the ion conductive material in the elastic layer 635 is preferably 0.1 mass part or more and 2 mass parts or less per 100 mass parts of the elastic material.

The elastic layer 635 may further contain one or more additives such as a plasticizer, a filler, a vulcanizing agent, a vulcanizing accelerator, an aging inhibitor, a scorch inhibitor, a dispersant, and a release agents.

The surface layer 636 contains a binder resin, conductive particles, and resin particles. As the binder resin, a polyamide resin may be used, with a nylon resin being more preferable. Specifically, as the nylon resin, a copolymer nylon resin “PA100-AS” (manufactured by T&K TOKA Co., Ltd.) may be used. A content ratio of binder resin in surface layer 636 is preferably 25 mass % or more and 60 mass % or less, and more preferably 35 mass % or more and 45 mass % or less. By setting the content ratio to 25 mass % or more, sufficient strength of surface layer 636 can be ensured, and by setting it to 60 mass % or less, it becomes easier to ensure the amounts of the resin particles and the conductive particles in surface layer 636.

The conductive particles impart appropriate conductivity to the surface layer. Examples of the conductive particles include carbon black, graphite, and metal oxide particles. Examples of the metal oxide include potassium titanate, iron oxide, titanium oxide, zinc oxide, tin oxide, antimony-doped tin oxide, and phosphorus-doped tin oxide. Carbon black is more preferable as the conductive particles.

The resin particles impart an appropriate surface roughness to the surface layer 636. Example of the resin used to form the resin particles include a (meth)acrylic resin, a urethane resin, a silicone resin, a polyester resin, a polystyrene resin, a styrene-(meth)acrylic resin, and a polyolefin resin. The acrylic resin is more suitable, and specifically, “MZ-5HN” (crosslinked acrylic dispersed particles, manufactured by Soken Chemical Co., Ltd.) made from crosslinked polymethyl methacrylate can be used.

The charging roller 631 is preferably such that the surface rotational resistance, i.e., the surface of the surface layer 636, is 5.2 log Ω or more and 6.1 log Ω or less. This rotational resistance can be adjusted by varying a content of the conductive particles in the surface layer 636. Specifically, when using carbon black and tin oxide particles as the conductive particles, by setting a content of carbon black to 5 phr and a content of tin oxide particles to 8 phr or more and 40 phr or less, the rotational resistance can be 5.2 log Ω or more and 6.1 log Ω or less. Note that the “phr” denotes mass parts of carbon black or tin oxide particles per 100 mass parts of the elastic material.

### [Method for Manufacturing Charging Roller]

A method for manufacturing the charging roller 631 will be described. The charging roller 631 can be manufactured by forming the elastic layer 635 on the conductive shaft 634 and forming the surface layer 636 on the elastic layer 635. The elastic layer 635 can be formed by preparing a composition of the aforementioned elastic material and conductive material, heating this composition, injecting it into a mold with the conductive shaft 634 set in place, and then cooling and demolding. The mixing of the elastic material and the conductive material can be conducted using a mixer.

The surface layer 636 can be formed by preparing coating liquid by mixing a solvent, the aforementioned binder resin, the conductive particles, and the resin particles, applying the coating liquid to the elastic layer 635, and removing the solvent. The mixing of materials can be conducted using a wet dispersion machine such as a ball mill, a bead mill, or a roll mill.

The coating liquid can be applied using any method capable of uniformly coating the coating liquid, such as a dip coating method, a spray coating method, a spin coating method, a bar coating method, or a blade coating method. The solvent can be removed by heating, vacuuming, or a combination of heating and vacuuming, specifically using a high-temperature dryer or a vacuum dryer.

### [Effects of Image Forming Apparatus]

The image forming apparatus 100, as described above, includes the photosensitive member 65 having the relative dielectric constant of 3.7 or more and 6.2 or less, and the charging roller 631 having the surface rotational resistance of 5.2 log Ω or more and 6.1 log Ω or less. This allows a surface potential of the photosensitive member 65 to be lowered to 160 V or less. When the surface potential of the photosensitive member 65 increases, a “white area carrier phenomenon” easily occurs, where carriers move to the surface of the photosensitive member 65. However, by lowering the surface potential of the photosensitive member 65, the occurrence of this phenomenon can be suppressed.

In general, in the image forming apparatus, “smearing” occurs in an exposed area of the surface 65a to which the toner adheres in a low-temperature and low-humidity (LL) environment. However, in the image forming apparatus 100, by configuring the photosensitive member 65 and the charging roller 631 as described above, the occurrence of smearing can be suppressed. Furthermore, in general, in the image forming apparatus, the black spots occur on the recording medium due to localized charge injection into the photosensitive layer 652 in a high-temperature and high-humidity (HH) environment. However, in the image forming apparatus 100, by configuring the photosensitive member 65 and the charging roller 631 as described above, the occurrence of the black spots can be suppressed. As described above, the image forming apparatus 100 is capable of suppressing the effect of the environment when printing on printing quality.

### EXAMPLES

The photoconductive members and the charging rollers according to Examples of the present disclosure and Comparative Examples were manufactured, and various physical properties were measured. Additionally, printing performances of each image forming apparatus equipped with the manufactured photoconductive members and the charging rollers were evaluated.

### [Manufacturing of Photosensitive Member]

The photosensitive member was manufactured as follows: First, a rod-shaped ultrasonic oscillator was used to disperse the following materials in a solvent to prepare a coating liquid. A dispersion time was set to 10 minutes. The materials are: Y-type titanyl phthalocyanine as the charge-generating material, as shown in the (Formula 1), 60 mass parts of a substance as the hole-transport material, as shown in the (Formula 2), 50 mass parts of a substance as the electron-transport material, as shown in the (Formula 3), and 100 mass parts of polyarylate resin as the binder resin, as shown in the (Formula 4). A content of Y-type titanyl phthalocyanine varies depending on each of Examples and Comparative examples. The polyarylate resin has 40 mass parts of the repeating unit shown in (Formula 4), 10 mass parts of the repeating unit shown in (Formula 5), 25 mass parts of the repeating end group shown in (Formula 6), and 25 mass parts of the repeating unit shown in (Formula 7). The solvent is tetrahydrofuran in an amount of 500 mass parts.

Next, the prepared coating liquid was filtered through a filter with a pore size of 5 μm. The coating liquid was then applied to a surface of the conductive base using the dip coating method to form a coating film. The coating film was dried at 120° C. for 50 minutes to remove the solvent, thereby forming a photosensitive layer. A thickness of the photosensitive layer was approximately 35 μm. The photosensitive member was manufactured as described above.

### [Manufacturing of Charging Roller]

The charging roller was manufactured as follows: First, the following materials were stirred and mixed using a stirrer to prepare a composition. The materials were: 100 mass parts of epichlorohydrin rubber (“Epichloromer CG-102” (manufactured by Osaka Soda Co., Ltd.)), 5 mass parts of a vulcanization aid (zinc oxide, “Zinc Oxide Type 2” (manufactured by Mitsui Metal Co., Ltd.)), 1.5 mass parts of a vulcanization accelerator (MBT (2-Mercaptobenzothiazole), “Nocceler M-P” (manufactured by Ouchi Shinsei Chemical Industry Co., Ltd.)), 1 mass parts of sulfur (“Sulfax PS” (manufactured by Tsurumi Chemical Industry Co., Ltd.), 50 mass parts of a filler (calcium carbonate, “Hakuenka CC” (manufactured by Shiraishi Industrial Co., Ltd.)), 20 mass parts of an electronic conductive material (carbon black, “Asahi #50” (manufactured by Asahi Carbon Co., Ltd.)), and 0.5 mass parts of ion conductive material (sodium trifluoroacetate).

A conductive shaft (diameter 6 mm) was set in a molding die, the above composition was injected into the molding die, heated at 160° C. for 20 minutes, cooled, demolded to from an elastic layer with a thickness of 1.8 mm around an outer circumference of the conductive shaft.

Next, the following materials were dispersed in a solvent using a ball mill to prepare the coating liquid. The materials were: as the binder resin, 100 mass parts of a copolymer nylon resin (“PA100-AS” (manufactured by T&K TOKA Co., Ltd.)); as the resin particles, 50 mass parts of acrylic particles in the form of cross-linked acrylic dispersed in a solvent (“MZ-5HN” (manufactured by Soken Chemical Co., Ltd.)), and as the conductive particles, 5 mass parts of tin oxide particles (“SP2” (manufactured by Mitsubishi Materials Corporation)) and carbon black (manufactured by Tokai Carbon Co., Ltd.). A content of tin oxide particles varies depending on Examples and Comparative Examples. The solvent used was 1-butanol.

Next, the coating liquid prepared above was applied to an outer periphery of the elastic layer using a blade coating method to form a coating film with a thickness of 10 μm. The coating film was then dried in an electric furnace at 120° C. for 40 minutes to remove the solvent, thereby forming the surface layer. The charging roller was manufactured as described above.

### [Measurement]

Various measurements were conducted on the photosensitive member, the charging roller, and the image forming apparatus equipped with these components, which were prepared as described above.

### (Measuring Inflow Current of Photosensitive Member)

Using an evaluation machine “TASKalf MA4500ci” (manufactured by Kyocera Document Solutions) for the image forming apparatus, the current flowing into the photosensitive member was measured when the photosensitive member was charged to V0 (initial surface potential): 470 V. The current was measured using a microampere meter “MA-100N” (manufactured by Narika).

### (Measuring Rotational Resistance of Charging Roller)

The charging roller was rotated under a load of 10 N, and a resistance value was measured when a voltage of 500 V was applied between an iron roller in contact with the surface layer and a conductive shaft for 5 seconds. “R8340 ULTRA HIGH RESISTANCE METER” (manufactured by ADVANTEST) was used to measure the resistance value.

### (Durability Test)

Printing was conducted using the evaluation machine “TASKalf MA4500ci” (manufactured by Kyocera Document Solutions) for the image forming apparatus. A print pattern was a 5% concentration text image, a print method was continuous printing, the number of prints was 100,000 sheets, and the evaluation paper was “Askul MultiPaper Super Economy+.” A charging polarity of the charging roller was positive, an applied voltage to the charging roller was DC voltage, and a transfer method was an intermediate transfer method.

### (Smearing Evaluation)

The above-described durability test was conducted in an environment with a temperature of 23° C. and humidity of 50%. White paper was printed in the LL environment (temperature: 10° C., humidity: 10%) to obtain each image for evaluating the smearing. A value obtained by subtracting an image density of base paper from an average value of the image density of three points within the image on the white paper was defined as smearing density. The smearing density was evaluated as follows: “Evaluation A”: 0.010 or less, “Evaluation B”: greater than 0.010 but 0.020 or less, and “Evaluation C”: greater than 0.020.

### (Sensitivity Measurement)

The above-described durability test was conducted in an environment with a temperature of 23° C. and humidity of 50%, and the surface potential of the photosensitive member was measured. A charging potential of the charging roller was 470±30 V, exposure intensity was a wavelength of 780 nm, a half-width was 20 nm, and light intensity was 1.16 μJ/m². The surface potential was measured using a surface potential meter “MODEL 344” (manufactured by TREK) and a potential measurement probe (manufactured by TREK).

### (Black Spot Evaluation)

The above-described durability test was conducted in an environment with a temperature of 23° C. and humidity of 50%. White paper was printed under the HH (temperature: 32.5° C., humidity: 80%) environment, and presence or absence of the black spots was confirmed. If no black spots were observed, it was classified as “Non-occurred,” if one or more black spots were observed, it was classified as “Occurred.”

The following Table 1 shows each configuration of the photosensitive member and the charging roller and evaluation results for respective examples.

TABLE 1

| | Photosensitive member | | | | Charging roller | | Evaluation result | | | |
|---|---|---|---|---|---|---|---|---|---|---|
| | Configuration | | Properties | | Configuration | Properties | Potential | Image | | |
| | Film | CGM | Inflow | Relative | Amount of | Rotational | Sensitivity | LL smearing | HH black | |
| | thickness | amount | current | dielectric | tin oxide | resistance | (V) 160 V | Non- | spot Non- | |
| | (μm) | (phr) | (μC) | constant | (phr) | (logΩ) | or less | occurrence | occurrence | Judgment |
| Example 1 | 35.0 | 3 | 31.1 | 4.3 | 20 | 5.6 | 142 | A | Not | ∘ |
| | | | | | | | | | occurred | |
| Example 2 | 35.1 | 3 | 31.3 | 4.3 | 8 | 6.1 | 138 | A | Not | ∘ |
| | | | | | | | | | occurred | |
| Example 3 | 34.9 | 3 | 31.3 | 4.3 | 10 | 5.8 | 140 | A | Not | ∘ |
| | | | | | | | | | occurred | |
| Example 4 | 25.2 | 3 | 44.3 | 4.4 | 20 | 5.6 | 148 | A | Not | ∘ |
| | | | | | | | | | occurred | |
| Example 5 | 40.0 | 3 | 27.8 | 4.4 | 20 | 5.6 | 145 | A | Not | ∘ |
| | | | | | | | | | occurred | |
| Example 6 | 35.1 | 3 | 30.8 | 4.2 | 40 | 5.2 | 142 | A | Not | ∘ |
| | | | | | | | | | occurred | |
| Example 7 | 35.1 | 5 | 36.5 | 5.0 | 20 | 5.6 | 131 | A | Not | ∘ |
| | | | | | | | | | occurred | |
| Example 8 | 35.1 | 6 | 39.7 | 5.5 | 20 | 5.6 | 125 | A | Not | ∘ |
| | | | | | | | | | occurred | |
| Example 9 | 35.0 | 7 | 45.0 | 6.2 | 20 | 5.6 | 120 | A | Not | ∘ |
| | | | | | | | | | occurred | |
| Example 10 | 35.2 | 2 | 27.0 | 3.7 | 20 | 5.6 | 151 | A | Not | ∘ |
| | | | | | | | | | occurred | |
| Example 11 | 35.0 | 7 | 45.0 | 6.2 | 40 | 5.2 | 120 | A | Not | ∘ |
| | | | | | | | | | occurred | |
| Example 12 | 35.2 | 2 | 27.0 | 3.7 | 40 | 5.2 | 153 | A | Not | ∘ |
| | | | | | | | | | occurred | |
| Example 13 | 35.3 | 2 | 27.0 | 3.7 | 8 | 6.1 | 149 | A | Not | ∘ |
| | | | | | | | | | occurred | |
| Example 14 | 35.1 | 7 | 45.0 | 6.2 | 8 | 6.1 | 121 | A | Not | ∘ |
| | | | | | | | | | occurred | |
| Comparative | 35.0 | 2 | 27.0 | 3.7 | 0 | 6.9 | 151 | C | Not | x |
| Example 1 | | | | | | | | | occurred | |
| Comparative | 35.2 | 3 | 31.0 | 4.3 | 0 | 6.9 | 139 | C | Not | x |
| Example 2 | | | | | | | | | occurred | |
| Comparative | 35.0 | 3 | 31.3 | 4.3 | 5 | 6.7 | 138 | C | Not | x |
| Example 3 | | | | | | | | | occurred | |
| Comparative | 34.9 | 3 | 31.5 | 4.3 | 80 | 4.9 | 141 | A | Occurred | x |
| Example 4 | | | | | | | | | | |
| Comparative | 35.0 | 8 | 51.0 | 7.0 | 20 | 5.6 | 120 | B | Not | x |
| Example 5 | | | | | | | | | occurred | |
| Comparative | 35.3 | 1 | 15.0 | 2.1 | 20 | 5.6 | 192 | A | Not | x |
| Example 6 | | | | | | | | | occurred | |
| Comparative | 34.9 | 8 | 51.3 | 7.0 | 80 | 4.9 | 119 | A | Occurred | x |
| Example 7 | | | | | | | | | | |
| Comparative | 34.9 | 1 | 15.0 | 2.0 | 80 | 4.9 | 192 | A | Occurred | x |
| Example 8 | | | | | | | | | | |
| Comparative | 34.9 | 1 | 15.0 | 2.0 | 5 | 6.7 | 192 | C | Occurred | x |
| Example 9 | | | | | | | | | | |
| Comparative | 34.9 | 8 | 51.3 | 7.0 | 5 | 6.7 | 120 | C | Not | x |
| Example 10 | | | | | | | | | occurred | |

As shown in Table 1, in Examples 1 to 14, the amount of the charge-generating material (“CGM” in the table) in the photosensitive layer of the photosensitive member is 3 phr or more and 7 phr or less, and the relative dielectric constant (“εr” in the table) of the photosensitive member is 3.7 or more and 6.2 or less. As described above, the charge-generating material is Y-type titanyl phthalocyanine, and the “phr” denotes mass parts of Y-type titanyl phthalocyanine to 100 mass parts of the binder resin.

In Examples 1 to 14, an amount of tin oxide particles (“tin oxide” in Table) in the elastic layer of the charging roller is 8 phr or more and 40 phr or less, and the rotational resistance is 5.2 log Ω or more and 6.1 log Ω or less. The “phr” denotes mass parts of tin oxide particles per 100 mass parts of the elastic material.

Evaluation results for Examples 1 to 14 were all good (“0” in the table), with sensitivity (surface potential) of 160 V or less, the smearing evaluation of “A,” and the black spot evaluation of “A.”

On the other hand, in Comparative Examples 1 to 4, although the relative dielectric constant of the photosensitive member (“εr” in the table) was 3.7 or more and 6.2 or less, the rotational resistance of the charging roller was not 5.2 log Ω or more and 6.1 log Ω or less. Evaluation results showed that either the smearing evaluation or the black spot evaluation was not satisfactory, resulting in failure judgments (“x” in the table).

In Comparative Examples 5 and 6, although the rotational resistance of the charging roller was between 5.2 log Ω or more and 6.1 log Ω or less, the relative dielectric constant of the photosensitive member (“εr” in the table) was not 3.7 or more and 6.2 or less. Evaluation results showed that either the sensitivity (surface potential) or the smearing evaluation was not satisfactory, resulting in failure judgments (“x” in the table).

Furthermore, in Comparative Examples 7 to 10, the relative dielectric constant of the photosensitive member (“εr” in the table) was not 3.7 or more and 6.2 or less, and the rotational resistance of the charging roller was not 5.2 log Ω or more and 6.1 log Ω or less. Evaluation results showed that either one or two of the sensitivity (surface potential), the smearing evaluation, or the black spot evaluation were not satisfactory, resulting in failure judgments (“x” in the table).

Based on the above, by setting the relative dielectric constant of the photosensitive material to 3.7 or more and 6.2 or less, and the rotational resistance of a charging roller surface to 5.2 log Ω or more and 6.1 log Ω or less, as in Examples 1 to 14, it is possible to achieve good results for all of the sensitivity, the smearing evaluation, and the black spot evaluation.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus, comprising:
a photosensitive member having a relative dielectric constant of 3.7 or more and 6.2 or less;
a charging roller that charges the photosensitive member and has a surface rotational resistance of 5.2 log Ω or more and 6.1 log Ω or less; and
a power supply for applying a DC voltage to the charging roller.

2. The image forming apparatus according to claim 1, wherein the charging roller includes an elastic layer having conductivity and elasticity, and a surface layer formed on the elastic layer, and the surface layer contains a nylon resin, conductive particles, and acrylic particles.

3. The image forming apparatus according to claim 1, wherein the photosensitive member is a single-layer photosensitive member.
